(19) United States
(12) Patent Application Publication
(10) Pub. No.: US 2017/0060736 A1
(43) Pub. Date: Mar. 2, 2017

(54) Dynamic Memory Sharing

(71) Applicant: MediaTek Inc., Hsinchu City (TW)

(72) Inventors: Chien-Liang Lin, Hsinchu City (TW); Jing-Yen Huang, Hsinchu City (TW); Peng-An Chen, Taipei City (TW); Nicholas Ching Hui Tang, Hsinchu County (TW); Chung-Jung Lee, Taipei City (TW); Chin-Wen Chang, Taichung City (TW)

(21) Appl. No.: 15/350,607

(22) Filed: Nov. 14, 2016

Related U.S. Application Data
(60) Provisional application No. 62/264,958, filed on Dec. 9, 2015.

(51) Int. Cl. G06F 12/02; G06F 3/06

(52) U.S. Cl. CPC G06F 12/023; G06F 3/0604; G06F 3/0631; G06F 3/0637; G06F 3/0673; G06F 2212/1041

(57) ABSTRACT

Methods and apparatuses pertaining to dynamic memory sharing may involve sharing a first portion of a memory associated with a first module for use by a second module. The first portion of the memory may be reclaimed for use by the first module in real time upon a determination that there is an increase in demand for the memory by the first module that requires reclamation, such that the first module begins to use the first portion of the memory before the second module finishes a process of aborting to use the first portion of the first memory.

### CROSS REFERENCE TO RELATED PATENT APPLICATION(S)

The present disclosure is part of a non-provisional application claiming the priority benefit of U.S. Patent Application No. 62/264,958, filed on 9 Dec. 2015, which is incorporated by reference in its entirety.

### TECHNICAL FIELD

The present disclosure is generally related to memory management and, more particularly, to dynamic memory sharing.

### BACKGROUND

Unless otherwise indicated herein, approaches described in this section are not prior art to the claims listed below and are not admitted to be prior art by inclusion in this section.

In modern computing systems, different hardware modules, such as one or more processors and one or more hardware peripheral devices, operate independently and typically need buffer size large enough to process data. With limited amount of resources including memory, generally the hardware modules share the same memory. Most of the time, however, memory allocated for sharing tends not to be used and, yet, the allocated-but-not-used memory cannot be freed for use by other hardware module(s) because memory demand for the allocated memory can come at any time. Besides, the time it takes for memory allocation to change from one hardware module to another is typically not constantly short enough to meet memory demand.

In most existing designs of hardware modules, memory size for allocation is typically calculated based on the maximum memory consumption on different operational modes, speeds and statuses to meet system requirement. A hardware module cannot free up or reduce the size of its allocated memory because, if and when the hardware module needs to reclaim its allocated memory for use within a constant limited amount of time, it would be difficult to achieve so. Thus, a dedicated and fixed-size memory group is needed, and as a result memory cannot be dynamically allocated.

FIG. 7 illustrates an example scenario 700 of memory allocation under an existing approach. In scenario 700, some portions of a memory device 710 are dedicated for the use by Modules A, B and C, respectively. In the case of Module B, a portion of the memory designated for use by Module B is used by subsystem 1 and another portion of the memory designated for use by Module B is used by subsystem 2, with a remaining portion being a buffer. The amount of the buffer being utilized by Module B varies (e.g., low, high and highest as shown in FIG. 7) as Module B operates in different states, modes and speeds. Typically, the utilization of the buffer by Module B is low most of the time and is high less often. When the utilization of the buffer by Module B is low, the un-used portion of the buffer still cannot be used or shared by other modules (e.g., Module A or Module C). If the un-used portion of the buffer were to be used and shared by Module A or Module C, however, Module B would not be able to reclaim that portion of the buffer fast enough if and when Module B needs to utilize that portion of the buffer.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose a novel scheme for dynamic memory sharing. The proposed scheme avoids the issue described above with respect to the existing approach. Moreover, the proposed scheme enables real-time reclamation of a shared memory upon a detection or determination of the shared memory by a module with which the shared memory is associated.

In one aspect, a method in accordance with the present disclosure may involve sharing a first portion of a memory associated with a first module for use by a second module. The method may also involve determining whether there is any change in demand for the first portion of the memory by the first module that requires reclamation of the first portion of the memory for use by the first module. The method may further involve reclaiming the first portion of the memory for use by the first module in real time upon determining that there is an increase in demand for the memory by the first module that requires reclamation.

In another aspect, a method in accordance with the present disclosure may involve determining whether an amount of usage of a memory by a first module is below a threshold. The method may also involve sharing a first portion of the memory for use by a second module in response to a determination that the amount of usage of the memory by the first module is below the threshold. The method may additionally involve monitoring any change in demand for the memory by the first module after the sharing of the first portion of the memory. The method may further involve reclaiming the first portion of the memory for use by the first module in response to the monitoring indicating an increase in demand for the memory by the first module.

In another aspect, an apparatus in accordance with the present disclosure may include a memory device comprising at least a first memory configured to store data. The apparatus may also include a processor operatively coupled to the first memory. The processor may designate the first memory for use by a first module. The processor may determine whether an amount of usage of the first memory by the first module is below a first threshold. The processor may share a first portion of the first memory for use by a second module in response to a determination that the amount of usage of the first memory by the first module is below the first threshold. The processor may monitor any change in demand for the first memory by the first module after the sharing of the first portion of the first memory for use by the second module. The processor may reclaim the first portion of the first memory for use by the first module in real time upon the monitoring indicating an increase in demand for the first memory by the first module.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example scenario depicting the basic concept of the proposed scheme of the present disclosure.

FIG. 2 is a diagram of an example scenario in accordance with an implementation of the present disclosure.

FIG. 3 is a diagram of an example scenario in accordance with an implementation of the present disclosure.

FIG. 4 is a block diagram of an example apparatus in accordance with an implementation of the present disclosure.

FIG. 5 is a flowchart of an example process in accordance with an implementation of the present disclosure.

FIG. 6 is a flowchart of an example process in accordance with an implementation of the present disclosure.

FIG. 7 is a diagram of memory sharing under a conventional approach.

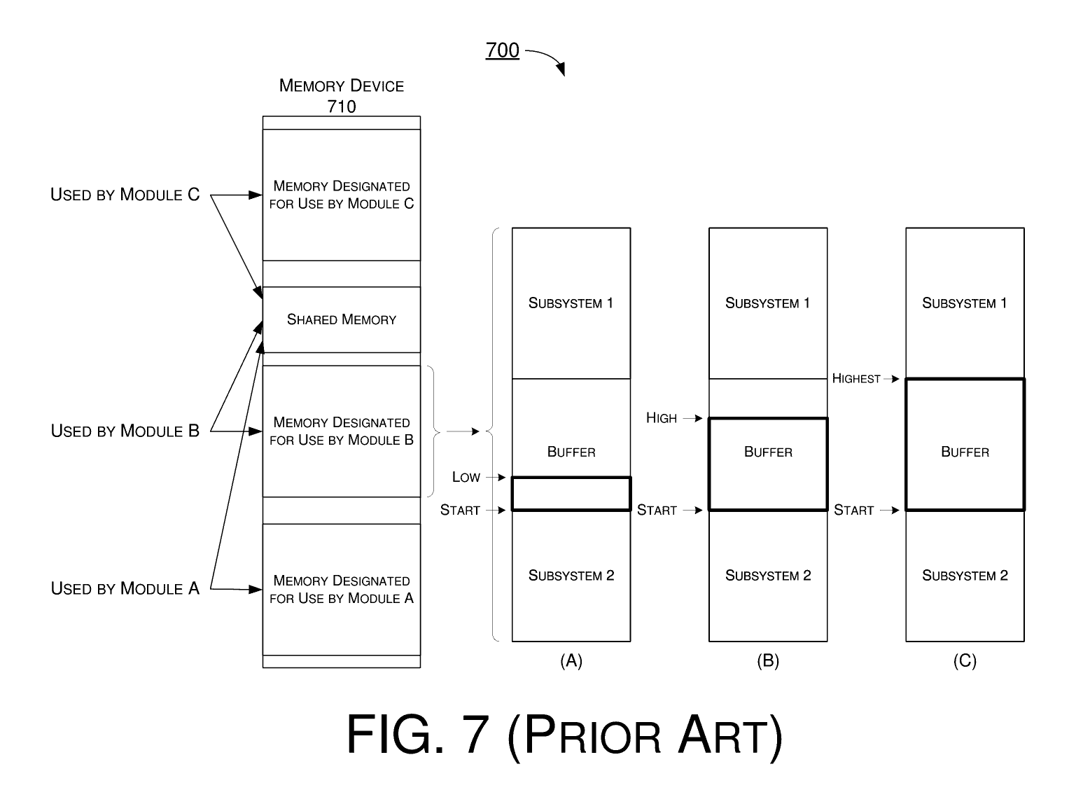

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

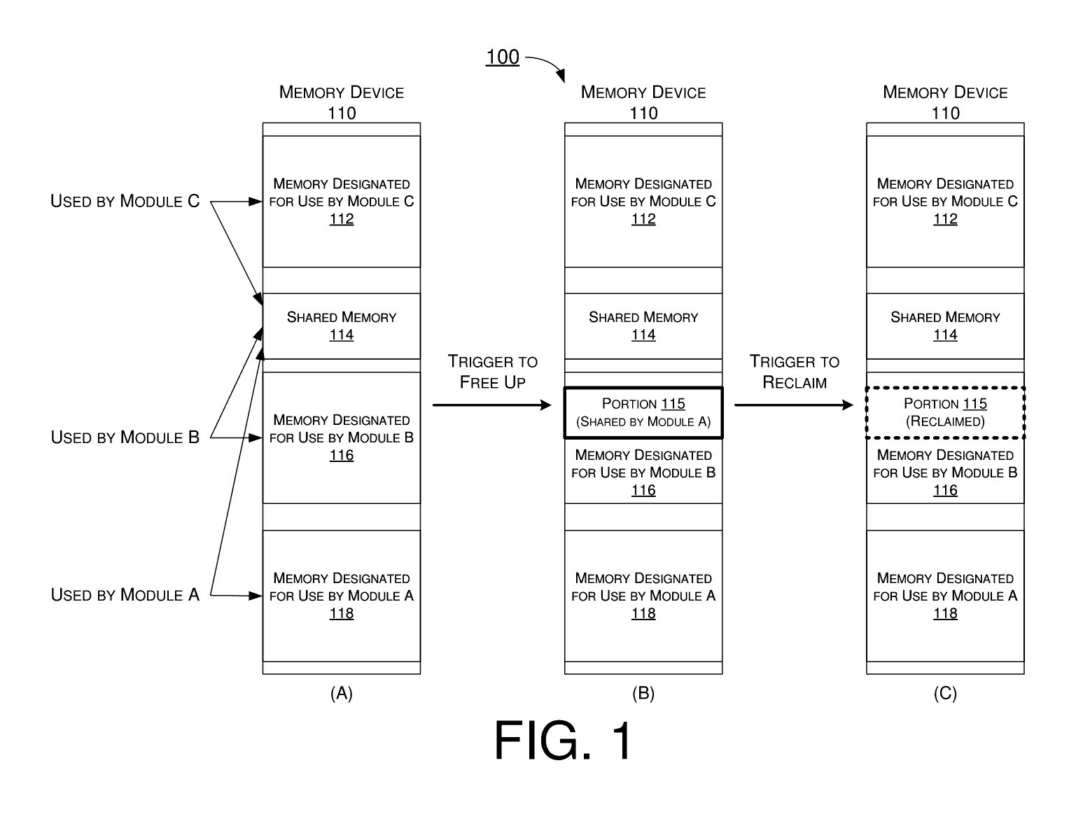

FIG. 1 illustrates an example scenario 100 depicting the basic concept of the proposed scheme of the present disclosure. In scenario 100, a memory device 110 may include memories each of which designated for use by a corresponding hardware module or software module or shared by multiple hardware and/or software modules. In the example shown in FIG. 1, memory device 110 may include a memory 112 that is designated for use by a Module C, which may be a hardware module or a software module; a memory 116 that is designated for use by a Module B, which may be a hardware module or a software module; a memory 118 that is designated for use by a Module A, which may be a hardware module or a software module; and a memory 114 that is shared by Modules A, B and C. Each of Modules A, B and C may fully utilize its associated memories 118, 116 and 112, respectively, at times. However, it is likely that most of the time at least one of Modules A, B and C does not fully utilize its associated memory. In the example shown in FIG. 1, Module B does not fully utilize memory 116 and, thus, one or more portions of memory 116 may be freed up for sharing with Module A and/or Module C.

Under the proposed scheme of the present disclosure, a control logic, a processor or Module B itself may monitor an amount of usage of memory 116 by Module B and determine whether the amount of usage is below a threshold (e.g., 20%, 15%, 10% or another percentage of memory 116). The threshold may be predefined and may be adjustable. When it is determined that the amount of usage of memory 116 by Module B is below the threshold, the control logic, processor or Module B may trigger a sharing process to share a portion 115 of memory 116 to either Module A or Module C. For instance, as part of the sharing process, the control logic, processor or Module B may configure a memory control unit to change ownership of portion 115 of memory 116 from Module B to Module A to result in portion 115 of memory 116 being available to Module A and unavailable to Module B. The memory control unit may be associated with memory device 110 as a whole or with one or more of Modules A, B and C. Also as part of the sharing process, the control logic, processor or Module B may notify Module A of the availability of portion 115 of memory 116 (e.g., notifying Module A that ownership of portion 115 of memory 116 has been changed from Module B to Module A) so that Module A may begin to utilize portion 115 of memory 116.

After portion 115 of memory 116 has been shared with Module A, the control logic, processor or Module B may continue to monitor any change in demand for memory 116 by Module B. Upon detecting or otherwise determining an increase in demand for memory 116 by Module B, the control logic, processor or Module B may trigger a reclaiming process to reclaim portion 115 of memory 116 for use by Module B. For instance, as part of the reclaiming process, the control logic, processor or Module B may configure the memory control unit to change ownership of portion 115 of memory 116 from Module A back to Module B to result in portion 115 of memory 116 being reclaimed and available to Module B but unavailable to Module A. Also as part of the reclaiming process, the control logic, processor or Module B may notify Module A of the unavailability of portion 115 of memory 116 (e.g., notifying Module A that ownership of portion 115 of memory 116 has been changed from Module A to Module B) so that Module A may initiate a process of aborting its utilization of portion 115 of memory 116.

Under the proposed scheme of the present disclosure, the configuring of the memory control unit to effect reclamation of portion 115 of memory 116 may happen within a predefined amount of time of the detection or determination that there is an increase in demand for memory 116 by Module B, which may be a constant and short duration of time. Accordingly, by configuring the memory control unit to change ownership of the shared portion 115 of memory 116 back to Module B within a constant and short amount of time of detection or determination that there is an increase in demand for memory 116 by Module B, portion 115 of memory 116 may become available to Module B by the time Module B actually needs to and/or starts to utilize an increased amount of memory 116 including portion 115. Advantageously, from the perspective of Module B, the reclamation of portion 115 of memory 116 is “real-time” since the reclamation of portion 115 of memory 116 does not result in any delay on the part of Module B as there is no waiting time between the time Module B needs to use portion 115 of memory 116 and the time Module B can actually begin to use portion 115 of memory 116 after reclamation. This is because the detection or determination of the increase in demand for memory 116 by Module B occurs sometime before the time Module B needs to use portion 115 of memory 116 and because the reclamation (e.g., configuring the memory control unit to change ownership of portion 115 of memory 116 back to Module B) takes place within a constant and short amount of time of the detection or determination.

Under the proposed scheme of the present disclosure, the reclamation of portion 115 of memory 116 may be abrupt from the perspective of Module A. That is, under the proposed scheme, Module B can begin to use portion 115 of memory 116 after being notified and after ownership has be re-configured with the memory control unit, even before Module A finishes the process of aborting its utilization of portion 115 of memory 116. This is because, in order to achieve a real-time reclamation of portion 115 of memory 116 for Module B, the change of ownership of portion 115 of memory 116 and notification to Module B of the availability of portion 115 of memory 116 take place within a constant and short duration of time to allow utilization of portion 115 of memory 116 by Module B regardless of whether Module A has finished the process of aborting its utilization of portion 115 of memory 116. As a result, Module A may need to handle fault situations, including synchronous and asynchronous external memory data aborts, due to the unavailability of portion 115 of memory 116.

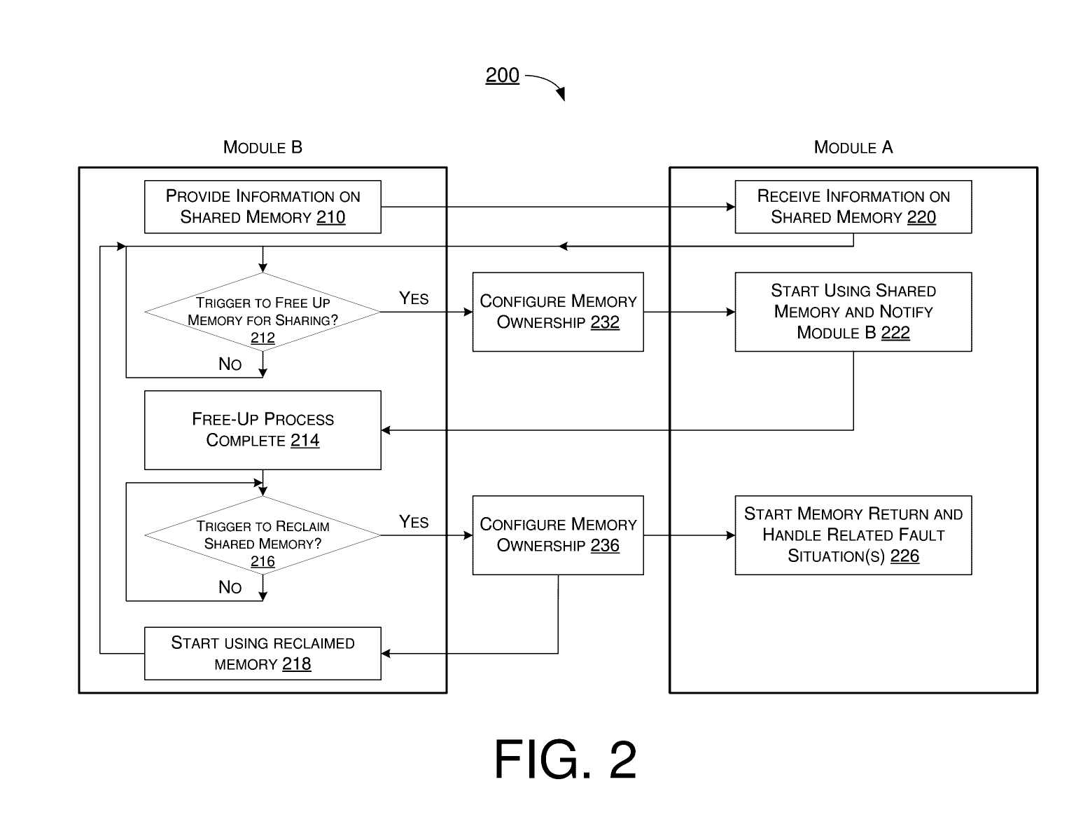

FIG. 2 illustrates an example scenario 200 in accordance with an implementation of the present disclosure. Scenario 200 may be a different perspective of the example shown in FIG. 1 with respect to scenario 100. That is, similar to scenario 100, scenario 200 involves Module B sharing, with Module A, a portion of a memory designated for use by Module B and later reclaiming that shared portion of the memory. Scenario 200 may involve a number of tasks and/or operations including, for example and without limitation, those shown in FIG. 2 such as 210, 212, 214, 216, 218, 220, 222, 226, 232 and 236.

At 210, Module B may provide information on a shared memory (e.g., portion 115 of memory 116) to Module A upon a determination that the amount of usage of memory 116 by Module B is below a certain threshold. At 220, Module A may receive the information on the shared memory from Module B. At 212, Module B may perform a loop operation in determining whether or not to trigger a sharing or free-up process to free up the memory (or a portion thereof) for use by Module A. At 232, upon a positive determination to trigger the sharing or free-up process to free up the memory, Module B (or a control logic or processor) may configure a memory control unit to change ownership of the shared memory from Module B to Module A as well as notify Module A of such change in ownership of the shared memory. At 222, Module A may start to use the shared memory and notify or otherwise acknowledge to Module B. At 214, upon receiving acknowledgement from Module A, Module B may consider the sharing or free-up process complete. Thereafter, at 216, Module B may perform a loop operation in determining whether or not to trigger a reclaiming process to reclaim the shared memory (e.g., by monitoring whether there is an increase in demand for memory by Module B). At 236, upon a positive determination to trigger the reclaiming process to reclaim the shared memory, Module B (or a control logic or processor) may configure the memory control unit to change ownership of the shared memory from Module A back to Module B as well as notify Module A of such change in ownership of the shared memory. At 226, Module A may start a process to abort its utilization of the shared memory to return the shared memory to Module B, including handling related fault situations (e.g., synchronous and asynchronous external memory data aborts). At 218, Module B may start to use the reclaimed memory (e.g., portion 115 of memory 116). At this point some of the above-described tasks and/or operations may repeat, starting at 212.

### Illustrative Implementations

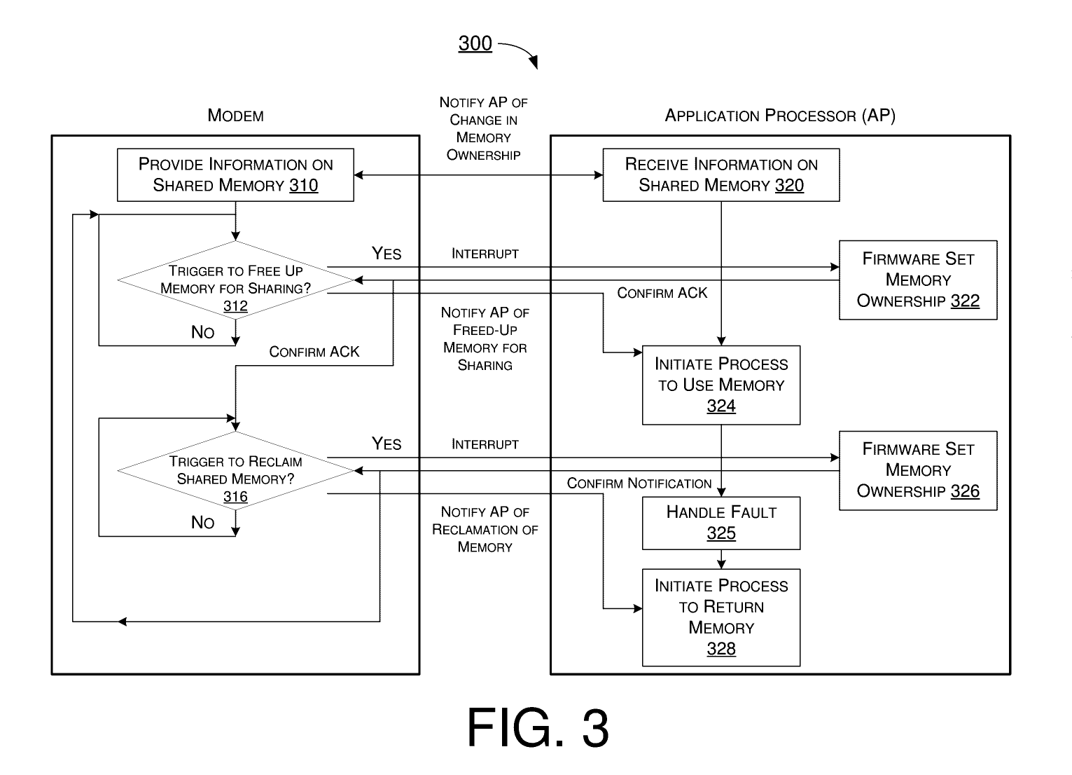

FIG. 3 illustrates an example scenario 300 in accordance with an implementation of the present disclosure. Scenario 300 may be an example implementation of scenario 100 and/or scenario 200. Scenario 300 involves a modem sharing, with an application processor (AP), a portion of a memory designated for use by the modem and later reclaiming that shared portion of the memory. Scenario 300 may involve a number of tasks and/or operations including, for example and without limitation, those shown in FIG. 3 such as 310, 312, 316, 320, 322, 324, 325, 326 and 328.

At 310, model (or a memory control unit associated with modem) may provide information on a shared memory to AP upon a determination that the amount of usage of memory by modem is below a certain threshold. At 320, AP may receive the information on the shared memory from modem (or the memory control unit associated with modem). At 312, modem may perform a loop operation in determining whether or not to trigger a sharing or free-up process to free up the memory (or a portion thereof) for use by AP. Upon a positive determination to trigger the sharing or free-up process to free up the memory, modem (or the memory control unit associated with modem) may send an interrupt signal to AP. AP may, in turn, receive the interrupt in a monitoring mode and transfer control to a firmware associated with AP. The firmware may modify a setting to change ownership of the shared memory from modem to AP. AP may also send an acknowledgement signal back to modem to confirm completion of change of ownership. Then, modem may, through a software protocol interface, notify AP about the change in ownership of the shared memory. At 324, an AP protocol handler may process a modem free memory request and start using the shared memory. Upon receiving acknowledgement from AP, modem may consider the sharing or free-up process complete.

In some implementations, AP may limit its usage of the shared memory to certain tasks among all tasks for which AP may use a given memory. For instance, AP may use the shared memory for purposes that would be relatively quick and simple to terminate (e.g., file cache memory). This is because, under the proposed scheme, the reclamation of the shared memory is real-time such that modem can begin to use the reclaimed memory even before AP finishes a process of aborting its utilization of the shared memory.

Thereafter, at 316, modem may perform a loop operation in determining whether or not to trigger a reclaiming process to reclaim the shared memory (e.g., by monitoring whether there is an increase in demand for memory by modem). Upon a positive determination to trigger the reclaiming process to reclaim the shared memory, modem (or the memory control unit associated with modem) may send an interrupt signal to AP. AP may, in turn, receive the interrupt in the monitoring mode and transfer control to the firmware associated with AP. The firmware may modify a setting to change ownership of the shared memory from AP back to modem. AP may also send a notification signal back to modem to confirm completion of change of ownership. Modem (or the memory control unit associated with modem) may start using the memory after receiving the confirm notification from AP. At 325, AP (or a memory control unit associated with AP) may handle fault situations such as, for example and without limitation, synchronous and asynchronous external memory data aborts. Modem may, through a software protocol interface, send a notification to AP to request AP (or the memory control unit associated with AP) to stop using the memory. At 328, AP (or the memory control unit associated with AP) may initiate a process to return the memory and abort using the memory. At this point some of the above-described tasks and/or operations may repeat, starting at 312.

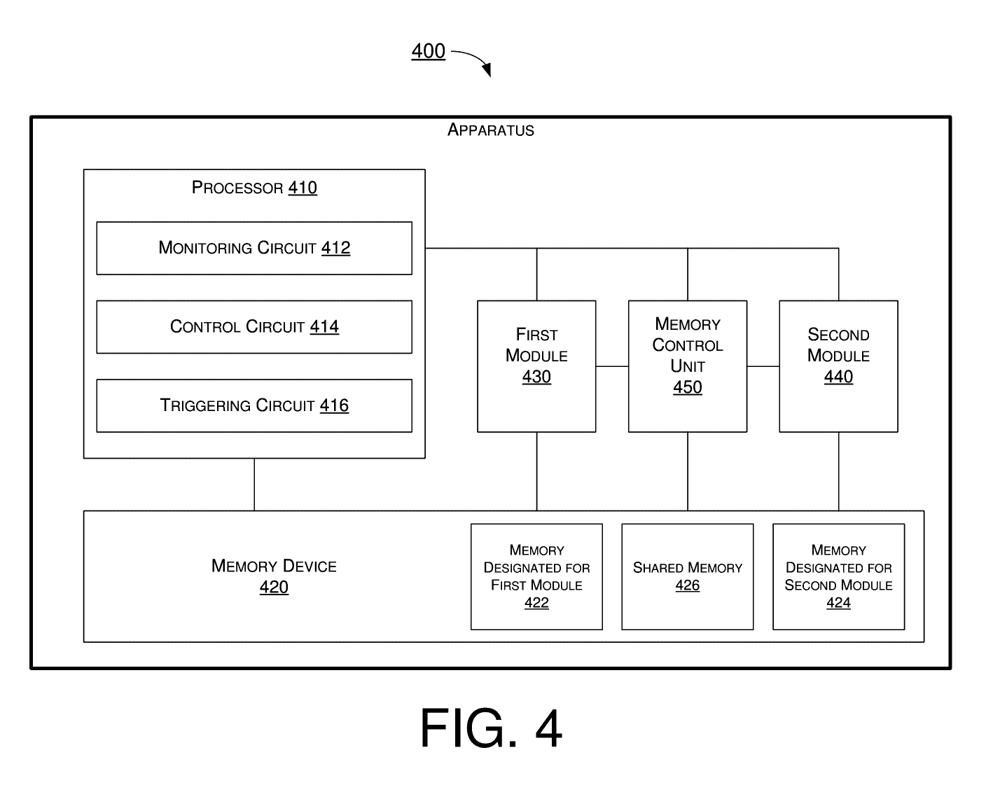

FIG. 4 illustrates an example apparatus 400 in accordance with an implementation of the present disclosure. Apparatus 400 may perform various functions to implement schemes, techniques, processes and methods described herein pertaining to dynamic memory sharing, including scenarios 100, scenario 200 and scenario 300 described above as well as process 500 and process 600 described below. Apparatus 400 may be a part of an electronic apparatus, which may be a portable or mobile apparatus, a wearable apparatus, a wireless communication apparatus or a computing apparatus. For instance, apparatus 400 may be implemented in a smartphone, a smartwatch, a smart bracelet, a smart necklace, a personal digital assistant, or a computing equipment such as a tablet computer, a laptop computer, a notebook computer, a desktop computer, or a server. Alternatively, apparatus 400 may be implemented in the form of one or more integrated-circuit (IC) chips such as, for example and not limited to, one or more single-core processors, one or more multi-core processors, or one or more complex-instruction-set-computing (CISC) processors. Apparatus 400 may include at least those components shown in FIG. 4, such as a processor 410 and a memory device 420.

Additionally, apparatus 400 may include a first module 430, a second module 440 and a memory control unit 450. Apparatus 400 may further include other components not pertinent to the proposed scheme of the present disclosure (e.g., internal power supply, communication device, display device and/or user interface device), which are neither shown in FIG. 4 nor described below in the interest of simplicity and brevity.

Memory device 420 may include a number of memories configured to store data. In the example shown in FIG. 4, memory device 420 includes at least a first memory 422, which is designated for use by first module 430, a second memory 424, which is designated for use by second module 440, and a shared memory 426 for use by first module 430 and/or second module 440. Memory device 420 may be implemented by any suitable technology and may include volatile memory and/or non-volatile memory. For example, memory device 420 may include a type of random access memory (RAM) such as dynamic RAM (DRAM), static RAM (SRAM), thyristor RAM (T-RAM) and/or zero-capacitor RAM (Z-RAM). Alternatively or additionally, memory device 420 may include a type of read-only memory (ROM) such as mask ROM, programmable ROM (PROM), erasable programmable ROM (EPROM) and/or electrically erasable programmable ROM (EEPROM). Alternatively or additionally, memory device 420 may include a type of non-volatile random-access memory (NVRAM) such as flash memory, solid-state memory, ferroelectric RAM (FeRAM), magnetoresistive RAM (MRAM) and/or phase-change memory.

Each of first module 430, second module 440 and memory control unit 450 may be implemented as hardware or software. In cases of hardware module, first module 430, second module 440 and/or memory control unit 450 may be implemented by electronic circuitry including, for example and without limitation, one or more transistors, one or more diodes, one or more capacitors, one or more resistors, one or more inductors, one or more memristors and/or one or more varactors.

Memory control unit 450 may be associated with memory device 420. Alternatively or additionally, memory control unit 450 may be associated with first module 430 and/or second module 440. In some implementations, memory control unit 450 may include multiple memory control units each of which associated with memory device 420, first module 430 or second module 440, respectively.

In one aspect, processor 410 may be implemented in the form of one or more single-core processors, one or more multi-core processors, or one or more CISC processors. That is, even though a singular term “a processor” is used herein to refer to processor 410, processor 410 may include multiple processors in some implementations and a single processor in other implementations in accordance with the present disclosure. In another aspect, processor 410 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, processor 410 is a special-purpose machine specifically designed, arranged and configured to perform specific tasks including dynamic memory sharing in accordance with various implementations of the present disclosure.

Processor 410, as a special-purpose machine, may include non-generic and specially-designed hardware circuits that are designed, arranged and configured to perform specific tasks pertaining to dynamic memory sharing in accordance with various implementations of the present disclosure. For instance, processor 410 may include a monitoring circuit 412, a control circuit 414 and a triggering circuit 416 that, together, perform specific tasks and functions to render dynamic memory sharing in accordance with various implementations of the present disclosure. For instance, control circuit 414 may designate the first memory 422 for use by first module 430 and determine whether an amount of usage of first memory 422 by first module 430 is below a first threshold. Control circuit 414 may determine that at least a first portion of first memory 422 is to be shared with second module 440 upon a determination that the amount of usage of first memory 422 by first module 430 is below the first threshold. Triggering circuit 416 may send a signal to first module 430, second module 440 and/or memory control unit 450 to trigger a sharing or free-up process similar to that described above with respect to scenario 200 and/or scenario 300 to effect sharing of the first portion of first memory 422 with second module 440 (e.g., by change in ownership of the first portion of first memory 422 from first module 430 to second module 440). Monitoring circuit 412 may monitor any demand for first memory 422 by first module 430 after the sharing of at least the first portion of first memory 422 for use the second module 440. Control circuit 414 may determine that the firs portion of first memory 422 is to be reclaimed upon monitoring circuit 412 indicating an increase in demand for first memory 422 by first module 430. Triggering circuit 416 may send a signal to first module 430, second module 440 and/or memory control unit 450 to trigger a reclaiming process similar to that described above with respect to scenario 200 and/or scenario 300 to effect reclamation of the first portion of first memory 422 (e.g., by change in ownership of the first portion of first memory 422 from second module 440 back to first module 430).

In some implementations, in reclaiming the first portion of first memory 422 for use by first module 430, control circuit 414 may reclaim the first portion of first memory 422 for use by first module 430 such that first module 430 begins to use the first portion of first memory 422 before second module 440 finishes a process of aborting to use the first portion of first memory 422.

In some implementations, in sharing the first portion of first memory 422 for use by second module 440, control circuit 414 may configure memory control unit 450 (or have trigger circuit 416 trigger memory control unit 450) to change ownership of the first portion of first memory 422 from first module 430 to second module 440. Moreover, control circuit 414 may notify second module 440 that the ownership of the first portion of first memory 422 has been changed to second module 440. In some implementations, in reclaiming the first portion of first memory 422 for use by first module 430, control circuit 414 may configure memory control unit 450 (or have triggering circuit 416 trigger memory control unit 450) to change the ownership of the first portion of first memory 422 from second module 440 to first module 430. Additionally, control circuit 414 may notify second module 440 that the ownership of the first portion of first memory 422 has been changed to first module 430.

In some implementations, in reclaiming the first portion of first memory 422 for use by first module 430, control circuit 414 may reclaim partially the first portion of first memory 422 for use by first module 430 such that a part of the first portion of first memory 422 continues to be available for use by second module 440.

In some implementations, processor 410 may further perform a number of other operations. For instance, control circuit 414 may designate second memory 424 of memory device 420 for use by second module 440. Control circuit 414 may also determine whether an amount of usage of second memory 424 by second module 440 is below a second threshold. In response to a determination that the amount of usage of second memory 424 by second module 440 is below the second threshold, control circuit 414 may share a second portion of the second memory for use by first module 430 (or another module which is not shown in FIG. 4). Monitoring circuit 412 may monitor any change in demand for second memory 424 by second module 440 after the sharing of the second portion of second memory 424 for use by first module 430 (or another module). Control circuit 414 may reclaim the second portion of second memory 424 for use by second module 440 in real time upon monitoring circuit 412 indicating an increase in demand for second memory 424 by second module 440 such that second module 440 begins to use the second portion of second memory 424 before first module 430 (or another module) finishes a process of aborting to use the second portion of second memory 424.

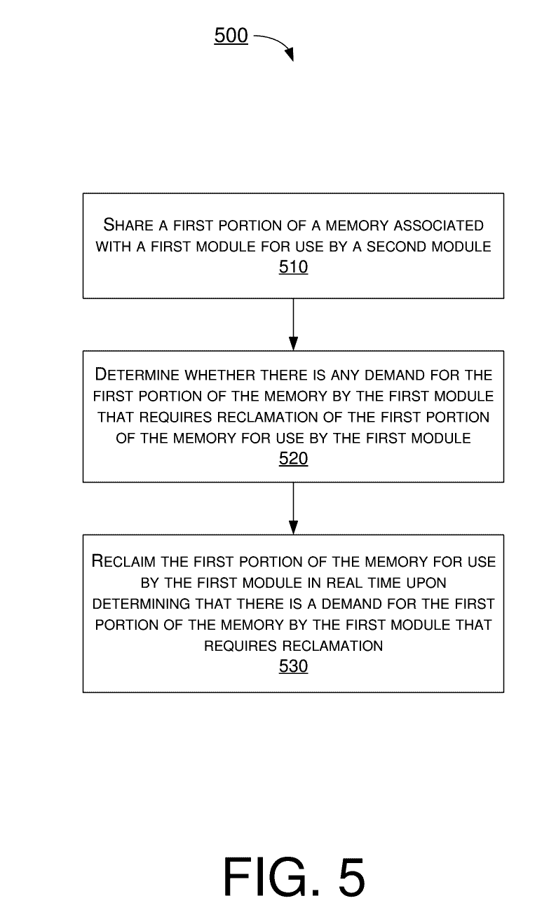

FIG. 5 illustrates an example process 500 in accordance with an implementation of the present disclosure. Process 500 may be an example implementation of any of scenario 100, scenario 200 and scenario 300, whether partially or completely, with respect to dynamic memory sharing. Process 500 may represent an aspect of implementation of features of apparatus 400. Process 500 may include one or more operations, actions, or functions as illustrated by one or more of blocks 510, 520 and 530. Although illustrated as discrete blocks, various blocks of process 500 may be divided into additional blocks, combined into fewer blocks, or eliminated, depending on the desired implementation. Moreover, the blocks of process 500 may executed in the order shown in FIG. 5 or, alternatively, in a different order. Process 500 may be implemented by apparatus 400. Solely for illustrative purposes and without limitation, process 500 is described below in the context of apparatus 400. Process 500 may begin at either block 510.

At 510, process 500 may involve processor 410 of apparatus 400 sharing or otherwise freeing up a first portion of memory 422, which is associated with or otherwise designated for use by first module 430, for use by second module 440. Process 500 may proceed from 510 to 520.

At 520, process 500 may involve processor 410 of apparatus 400 determining whether there is any change in demand for the first portion of memory 422 by first module 430 that requires reclamation of the first portion of memory 422 for use by first module 430. Process 500 may proceed from 520 to 530.

At 530, process 500 may involve processor 410 of apparatus 400 reclaiming the first portion of memory 422 for use by first module 430 in real time upon determining that there is an increase in demand for memory 422 by first module 430 that requires reclamation.

In some implementations, in reclaiming the first portion of memory 422 for use by first module 430 in real time, process 500 may involve processor 410 reclaiming the first portion of memory 422 for use by first module 430 such that first module 430 begins to use the first portion of memory 422 before second module 440 finishes a process of aborting to use the first portion of memory 422.

In some implementations, in sharing the first portion of memory 422 for use by second module 440, process 500 may involve processor 410 configuring memory control unit 450 to change ownership of the first portion of memory 422 from first module 430 to second module 440. In some implementations, in sharing the first portion of memory 422 for use by second module 440, process 500 may also involve processor 410 notifying second module 440 that the ownership of the first portion of memory 422 has been changed to second module 440.

In some implementations, in reclaiming the first portion of memory 422 for use by first module 430, process 500 may involve processor 410 configuring memory control unit 450 to change ownership of the first portion of memory 422 from second module 440 to first module 430. In some implementations, in reclaiming the first portion of memory 422 for use by first module 430, process 500 may also involve processor 410 notifying second module 440 that the ownership of the first portion of memory 422 has been changed to first module 430.

In some implementations, in reclaiming the first portion of memory 422 for use by first module 430, process 500 may involve processor 410 reclaiming partially the first portion of memory 422 for use by first module 430 such that a part of the first portion of memory 422 continues to be available for use by second module 440.

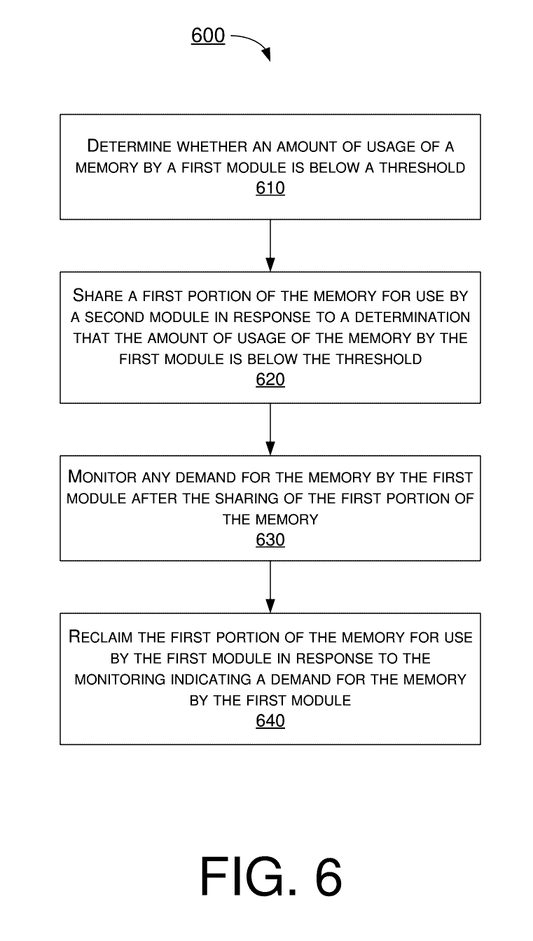

FIG. 6 illustrates an example process 600 in accordance with an implementation of the present disclosure. Process 600 may be an example implementation of any of scenario 100, scenario 200 and scenario 300, whether partially or completely, with respect to dynamic memory sharing. Process 600 may represent an aspect of implementation of features of apparatus 400. Process 600 may include one or more operations, actions, or functions as illustrated by one or more of blocks 610, 620, 630 and 640. Although illustrated as discrete blocks, various blocks of process 600 may be divided into additional blocks, combined into fewer blocks, or eliminated, depending on the desired implementation. Moreover, the blocks of process 600 may executed in the order shown in FIG. 6 or, alternatively, in a different order. Process 600 may be implemented by apparatus 400. Solely for illustrative purposes and without limitation, process 600 is described below in the context of apparatus 400. Process 600 may begin at either block 610.

At 610, process 600 may involve processor 410 of apparatus 400 determining whether an amount of usage of memory 422, which is associated with or otherwise designated for use by first module 430, by first module 430 is below a threshold. Process 600 may proceed from 610 to 620.

At 620, process 600 may involve processor 410 of apparatus 400 sharing a first portion of memory 422 for use by second module 440 in response to a determination that the amount of usage of memory 422 by first module 430 is below the threshold. Process 600 may proceed from 620 to 630.

At 630, process 600 may involve processor 410 of apparatus 400 monitoring any change in demand for memory 422 by first module 430 after the sharing of the first portion of memory 422. Process 600 may proceed from 630 to 640.

At 640, process 600 may involve processor 410 of apparatus 400 reclaiming the first portion of memory 422 for use by first module 430 in response to the monitoring indicating an increase in demand for memory 422 by first module 430.

In some implementations, in reclaiming the first portion of memory 422 for use by first module 430, process 600 may involve processor 410 reclaiming the first portion of memory 422 for use by first module 430 such that first module 430 begins to use the first portion of memory 422 before second module 440 finishes a process of aborting to use the first portion of memory 422.

In some implementations, in sharing the first portion of memory 422 for use by second module 440, process 600 may involve processor 410 configuring memory control unit 450 to change ownership of the first portion of memory 422 from first module 430 to second module 440. In some implementations, in sharing the first portion of memory 422 for use by second module 440, process 600 may also involve processor 410 notifying second module 440 that the ownership of the first portion of memory 422 has been changed to second module 440. In some implementations, in reclaiming the first portion of memory 422 for use by first module 430, process 600 may involve processor 410 configuring memory control unit 450 to change the ownership of the first portion of memory 422 from second module 440 to first module 430. In some implementations, in reclaiming the first portion of memory 422 for use by first module 430, process 600 may also involve processor 410 notifying second module 440 that the ownership of the first portion of memory 422 has been changed to first module 430.

In some implementations, in reclaiming the first portion of memory 422 for use by first module 430, process 600 may involve processor 410 reclaiming partially the first portion of memory 422 for use by first module 430 such that a part of the first portion of memory 422 continues to be available for use by second module 440.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
sharing a first portion of a memory associated with a first module for use by a second module;
determining whether there is any change in demand for the first portion of the memory by the first module that requires reclamation of the first portion of the memory for use by the first module; and
reclaiming the first portion of the memory for use by the first module in real time upon determining that there is an increase in demand for the memory by the first module that requires reclamation.

2. The method of claim 1, wherein the reclaiming of the first portion of the memory for use by the first module in real time comprises reclaiming the first portion of the memory for use by the first module such that the first module begins to use the first portion of the memory before the second module finishes a process of aborting to use the first portion of the memory.

3. The method of claim 1, wherein the sharing of the first portion of the memory for use by the second module comprises configuring a memory control unit to change ownership of the first portion of the memory from the first module to the second module.

4. The method of claim 3, wherein the sharing of the first portion of the memory for use by the second module further comprises notifying the second module that the ownership of the first portion of the memory has been changed to the second module.

5. The method of claim 1, wherein the reclaiming of the first portion of the memory for use by the first module comprises configuring a memory control unit to change ownership of the first portion of the memory from the second module to the first module.

6. The method of claim 5, wherein the reclaiming of the first portion of the memory for use by the first module further comprises notifying the second module that the ownership of the first portion of the memory has been changed to the first module.

7. The method of claim 1, wherein the reclaiming of the first portion of the memory for use by the first module comprises reclaiming partially the first portion of the memory for use by the first module such that a part of the first portion of the memory continues to be available for use by the second module.

8. A method, comprising:
determining whether an amount of usage of a memory by a first module is below a threshold;
sharing a first portion of the memory for use by a second module in response to a determination that the amount of usage of the memory by the first module is below the threshold;
monitoring any change in demand for the memory by the first module after the sharing of the first portion of the memory; and
reclaiming the first portion of the memory for use by the first module in response to the monitoring indicating an increase in demand for the memory by the first module.

9. The method of claim 8, wherein the reclaiming of the first portion of the memory for use by the first module comprises reclaiming the first portion of the memory for use by the first module such that the first module begins to use the first portion of the memory before the second module finishes a process of aborting to use the first portion of the memory.

10. The method of claim 8, wherein the sharing of the first portion of the memory for use by the second module comprises configuring a memory control unit to change ownership of the first portion of the memory from the first module to the second module.

11. The method of claim 10, wherein the sharing of the first portion of the memory for use by the second module further comprises notifying the second module that the ownership of the first portion of the memory has been changed to the second module.

12. The method of claim 10, wherein the reclaiming of the first portion of the memory for use by the first module comprises configuring the memory control unit to change the ownership of the first portion of the memory from the second module to the first module.

13. The method of claim 12, wherein the reclaiming of the first portion of the memory for use by the first module further comprises notifying the second module that the ownership of the first portion of the memory has been changed to the first module.

14. The method of claim 8, wherein the reclaiming of the first portion of the memory for use by the first module comprises reclaiming partially the first portion of the memory for use by the first module such that a part of the first portion of the memory continues to be available for use by the second module.

15. An apparatus, comprising:
a memory device comprising at least a first memory configured to store data; and
a processor operatively coupled to the first memory, the processor designed to perform operations comprising:
designating the first memory for use by a first module;
determining whether an amount of usage of the first memory by the first module is below a first threshold;
sharing a first portion of the first memory for use by a second module in response to a determination that the amount of usage of the first memory by the first module is below the first threshold;
monitoring any change in demand for the first memory by the first module after the sharing of the first portion of the first memory for use by the second module; and
reclaiming the first portion of the first memory for use by the first module in real time upon the monitoring indicating an increase in demand for the first memory by the first module.

16. The apparatus of claim 15, wherein, in reclaiming the first portion of the first memory for use by the first module, the processor reclaims the first portion of the first memory for use by the first module such that the first module begins to use the first portion of the first memory before the second module finishes a process of aborting to use the first portion of the first memory.

17. The apparatus of claim 15, wherein, in sharing the first portion of the first memory for use by the second module, the processor performs operations comprising:
configuring a first memory control unit to change ownership of the first portion of the first memory from the first module to the second module; and
notifying the second module that the ownership of the first portion of the first memory has been changed to the second module.

18. The apparatus of claim 17, wherein, in reclaiming the first portion of the first memory for use by the first module, the processor performs operations comprising:
configuring the first memory control unit to change the ownership of the first portion of the first memory from the second module to the first module; and
notifying the second module that the ownership of the first portion of the first memory has been changed to the first module.

19. The apparatus of claim 15, wherein, in reclaiming the first portion of the first memory for use by the first module, the processor reclaims partially the first portion of the first memory for use by the first module such that a part of the first portion of the first memory continues to be available for use by the second module.

20. The apparatus of claim 15, wherein the processor is further designed to perform operations comprising:
designating a second memory of the memory device for use by the second module;
determining whether an amount of usage of the second memory by the second module is below a second threshold;
sharing a second portion of the second memory for use by the first module in response to a determination that the amount of usage of the second memory by the second module is below the second threshold;
monitoring any change in demand for the second memory by the second module after the sharing of the second portion of the second memory for use by the first module; and
reclaiming the second portion of the second memory for use by the second module in real time upon the monitoring indicating an increase in demand for the second memory by the second module such that the second module begins to use the second portion of the second memory before the first module finishes a process of aborting to use the second portion of the second memory.
